(19) United States
(12) Patent Application Publication
(10) Pub. No.: US 2009/0006006 A1
(43) Pub. Date: Jan. 1, 2009

(54) Method and Apparatus For Determining An End of Service Life

(76) Inventors: Eric Jonathan Bauer, Freehold, NJ (US); John F. Olivieri, Norfolk, MA (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/771,178

(22) Filed: Jun. 29, 2007

(51) Int. Cl. G06F 17/18; G06F 19/00

(52) U.S. Cl. 702/34; 702/181

(57) ABSTRACT

A method and apparatus adapted to determine when an end of service life (EOSL) condition exists with respect to a unit under investigation (UUI) is provided. In one embodiment, for example, a method includes receiving data associated with a UUI. determining that the UUI has reached an EOSL condition in response to data indicative of an increasing rate of non-random failures, and invoking an EOSL process in response to the existence of an EOSL condition. The UUI may be any unit under investigation, such as a mechanical, electromechanical, or electrical component, sub-system, or system within, for example, a network.

### FIELD OF INVENTION

The invention relates to the field of business cost analysis and, more specifically, to the estimation of an end of service life (EOSL) condition associated with a particular product.

### BACKGROUND OF INVENTION

Electronic hardware experiences three distinct phases of life. In the early life phase, failure rates decrease as latent defects cause failures as part of “infant mortality.” In the useful life phase, failure rates are fairly low and constant. In the end of service life (EOSL) phase, failure rates increase as components wear out, drift or fail catastrophically. Failure may be defined as a catastrophic failure or a failure that, relatively speaking, renders the failed hardware ill-suited to its intended use.

Presently, the EOSL phase associated with electronic, mechanical and electromechanical hardware is primarily identified by escalating customer complaints. Unfortunately, by the time a customer realizes that some of their equipment has entered the EOSL phase the customer may have become extremely dissatisfied with the equipment as well as the equipment supplier.

### SUMMARY OF THE INVENTION

Various deficiencies in the prior art are addressed by the present invention of a method and apparatus adapted to determine when an end of service life (EOSL) condition exists with respect to a unit under investigation (UUI) such as a mechanical, electromechanical or electrical component, sub-system or system within, for example, a network.

According to one embodiment of the invention, a method of calculating an end of service life (EOSL) condition comprises receiving data associated with a unit under investigation (UUI); determining that the UUI has reached an EOSL condition in response to data indicative of an increasing rate of non-random failures; and invoking an EOSL process in response to the existence of an EOSL condition.

### BRIEF DESCRIPTION OF THE DRAWINGS

The teachings of the present invention can be readily understood by considering the following detailed description in conjunction with the accompanying drawings, in which:

FIG. 1 depicts several graphical representations of failure rates as a function of time useful in understanding the present invention;

FIG. 2 depicts a flow diagram of an end of service life determination routine according to an embodiment of the subject invention;

FIG. 3 depicts a flow diagram of a method for performing life data analysis according to an embodiment of the subject invention;

FIG. 4 graphically depicts Weibull plots for different failure rates; and

FIG. 5 depicts an apparatus useful for calculating EOSL in accordance with the subject invention.

To facilitate understanding, identical reference numerals have been used, where possible, to designate identical elements that are common to the figures.

### DETAILED DESCRIPTION OF THE INVENTION

Once hardware enters the end of life phase it becomes increasingly difficult and eventually impractical to maintain an adequate spares pool to keep systems operating with commercial service availability. That is, telecommunications systems, network systems and other complex systems having relatively long service lives include components, modules, assemblies and subassemblies that may become increasingly difficult to replace toward the end of life phase. Part of the invention resides in the recognition by the inventors that there is a need to accurately predict the onset of an end of service life (EOSL) phase associated with electronic equipment such that equipment owners may take appropriate action.

The present invention provides a methodology to assess the onset of an end of service life (EOSL) phase associated with electronic equipment such that equipment owner may take appropriate action. Appropriate action in response to an EOSL determination may include, for example, increasing sparing levels (as a temporary fix), planning to replace equipment in EOSL (either preventively or as failures occur), expecting lower service availability levels (e.g., dropping service-level agreements with customers), replacing EOSL equipment with next generation equipment and the like. Similarly, a determination that a suspect piece of equipment has not reached an EOSL phase may avoid the costs of unnecessarily replacing equipment.

Generally speaking, the subject invention provides an automatic technique enabling a methodical and timely identification of EOSL conditions or situation such that an equipment supplier and/or customer can actively monitor and manage the situation to achieve thereby higher service availability and lower operating expenses.

The subject invention presents the concept that end of service life conditions may be automatically determined using several operating parameters including failure rate versus time, type of failure, quality defect identification, randomness of failure, environmental conditions of equipment, customer specificity with respect to equipment failures, aging/design margin problems, TL9K rates and the like. In consideration of these factors, a comprehensive EOSL model and determination method has been developed. This EOSL model is described in greater detail with respect to the figures and following description using telecommunication equipment as the model product under warranty cost evaluation. However, the invention is useful for evaluating any type of product for any type of business that will benefit from an analysis of physical factors of units in the field.

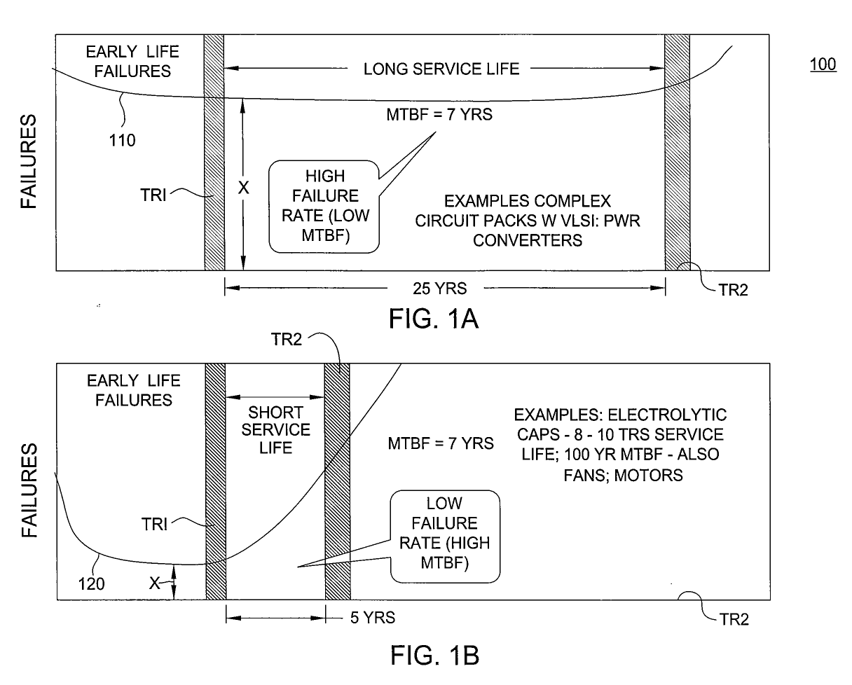

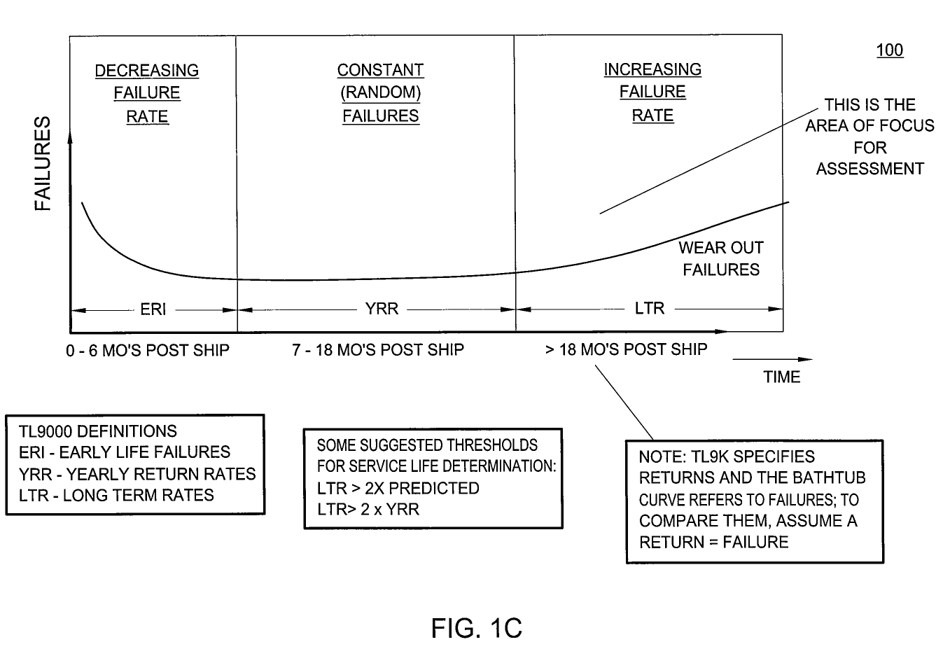

FIG. 1A depicts a graphical representation of failures as a function of time for apparatus having a long service life. Specifically, apparatus such as complex circuit packs with very large scale integrated (VLSI) circuits, power converters and the like may have a long service life such as 25 years with a mean time between failure (MTBF) of about seven years. A “bathtub curve” plot 110 indicates a relatively high number of early life failures, followed by a slightly lower number of service life failures (denoted as X), followed by an increasing number of failures at EOSL. The first transition region TR1 separates the early and service life time periods, a second transition region TR2 separates the service life and end of service life time periods.

FIG. 1B depicts a graphical representation of failures as a function of time for apparatus having a short service life. Specifically, apparatus such as electrolytic capacitors, fans, motors and the like may have a short service life such as eight to 10 years with a MTBF of about 50 years. A “bathtub curve” plot 120 indicates a high but rapidly dropping number of early life failures, followed by a low number of service life failures, followed by a rapidly increasing number of failures at EOSL. It is noted that the number of service life failures X for the high failure rate (low MTBF) apparatus of FIG. 1A is much higher than the number of service life failures X for the low failure rate (high MTBF) apparatus of FIG. 1B.

FIG. 1C depicts a graphical representation of failures as a function of time, which is graphically compared to TL9000 calculated return rates. Specifically, the TL 9000 model utilizes return rates as the driving data in characterizing service life expectations. TL9000 uses several definitions including early life failures (ERI) such as within the first 6 month after shipping a unit, yearly return rates (YYR) and long-term rates (LTR) such as 18 months after shipping the unit. Within the context of TL9000, some suggested thresholds for service life determinations comprise long-term rates greater than two times predicted return rates (LTR>2× Predicted Return Rate), long-term rates greater than two times annual return rate (LTR>2×YRR). Other thresholds may also be used. The inventors note that basing EOSL strictly on return rates or failure rates can be misleading.

Understanding whether a unit under investigation is at the end of its service life requires some information pertaining to normal operating expectations and typical EOSL failure modes. Data associated with the failure of electrical, mechanical and/or electromechanical components is processed to identify failure patterns indicative of EOSL failures rather than non-EOSL failures. EOSL-indicative trends in the failure data set are identified and used to determine if an EOSL condition exists with respect to a unit under investigation (UUI). EOSL-indicative parameters will be discussed in more detail below with respect to the various figures.

Electromechanical components exhibit decreasing early life failures and are primarily attributable to quality/manufacturing defects, while service life failures are primarily attributable to constant (random) failures, and increasing EOSL failures are primarily attributable to the wearing out of mechanical components. This wearing out process is accelerated and/or caused by factors such as bearing type, lubrication type, operating temperature, motor speed, contaminants and the like. Motors, fans, disk drives and the like usually experience mechanical failure of a bearing. Bearings may be operated 24 hours a day, seven days a week for approximately 5 to 10 years depending upon the quality of bearings and other factors associated. Switches, connectors and the like typically experience intermittent operation. Factors accelerating wear out such components include excessive temperature, wide temperature variations, vibration and the like.

Electrical components may exhibit an increasing failure rate for one component (nonrandom failures), as well as an increasing failure rate for a particular failure mode of the component. Increasing component failure rates and increasing failure rate for a particular mode may be indicative of an EOSL condition. Factors that accelerate the electrical component failure include increasing temperature, humidity, vibration, electoral stress and the like. Where these factors exist and are likely related to the failure mode, the overall system is likely not entering an end of service life condition.

Where failures of electrical, mechanical and/or electromechanical components exhibit a correlation with failure accelerating conditions (i.e., temperature, humidity, mechanical stress and vibration etc.), such failures likely do not indicate an EOSL condition for the module, subsystem or system including the component.

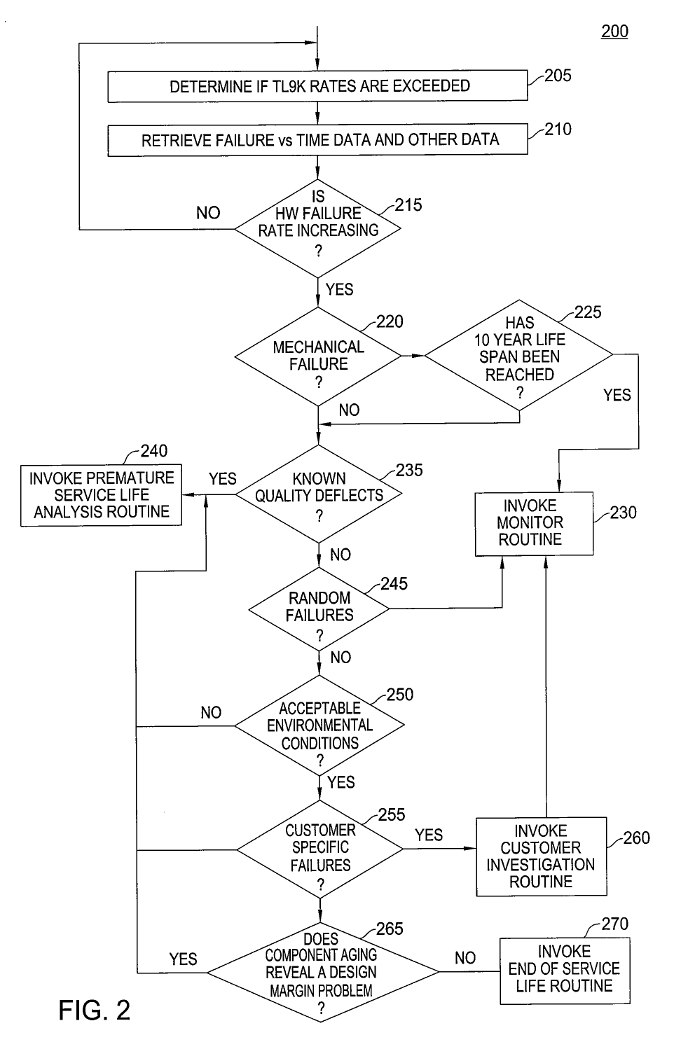

FIG. 2 depicts a flow diagram of an end of service life determination routine according to an embodiment of the subject invention. In a broad aspect of the invention, a series of physical condition parameters which denote certain physical states or dispositions of the item for which the EOSL modeling is being conducted are employed to arrive at an EOSL determination for the item.

Specifically, the method starts at optional step 205 were a determination is made as to whether TL9000 rates for a suspect piece of equipment or exceeded. That is, an optional step 205 a determination is made as to whether the expected service life of the unit under investigation has been reached. As previously noted, expected service life thresholds may be defined as twice predicted life, twice the yearly return right and so on.

At step 210, failure versus time data and other data is retrieved from a service database. A service database may be associated with particular types of equipment, particular customers, particular networks and the like. In essence, each time they hardware failure occurs the service database is updated with the time and nature of the hardware failure. The failure versus time data or failure rate is determined over predefined time period which may be different depending upon the type of hardware. In one embodiment, the predefined time period comprises several years (depending on the expected life span of the type of component and/or the wear out mechanism impacting the component. The other data will be described in more detail below with respect to the relevant steps of this method.

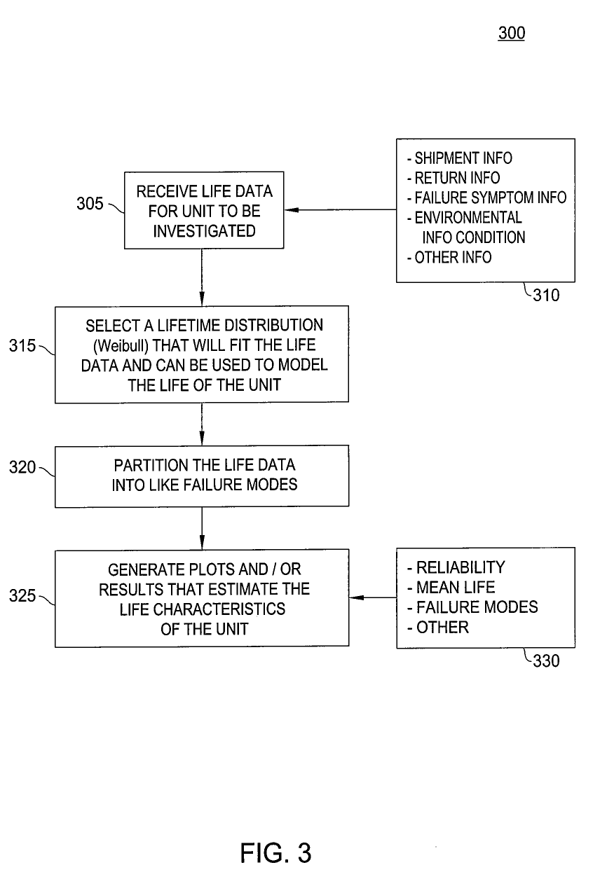

At step 215, a query is made as to whether the hardware failure rate is increasing. If the failure rate is not increasing, the method 200 returns to an initial monitoring step. The method 300 of FIG. 3 depicts a flow diagram of a method for performing life data analysis (including hardware failure rate determination) suitable for use in, for example, implementing steps 210 and/or 215.

If the failure rate is increasing, then at step 220 a determination is made as to whether a mechanical unit (motor) is failing. If a mechanical unit is failing, then at step 225 a determination is made as to whether a 10 year life (L10) condition has been reached. If the L10 condition has been reached, then a monitoring routine is invoked at step 230. Otherwise the method 200 proceeds to step 235.

At step 235, a determination is made as to whether any known quality defects are associated with the failing unit. If known quality defects exist, then a premature service life analysis routine is invoked at step 240. Otherwise, the method 200 proceeds to step 245.

At step 245, a determination is made as to whether the failing unit is associated with random failures. If the failing unit is associated with random failures, then the monitoring routine at step 230 is invoked. Otherwise, the method 200 proceeds to step 250.

At step 250, a determination is made as to whether acceptable environmental conditions exist with respect to the failing unit. If acceptable of environmental conditions do not exist, then the premature service life analysis routine is invoked at step 240. Otherwise, the method 200 proceeds to step 255.

At step 255, a determination is made as to whether the failing unit is associated with one or more specific customers. That is, at step 255 a determination is made as to whether one or more customers or owners of equipment including the failing unit are experiencing a higher level of failures than other customers or owners of such equipment. If a customer specific correlation to the failures is found, then a customer investigation routine is invoked at step 260, followed by the invoking of the monitor routine at step 230. Otherwise, the method 200 proceeds to step 265.

At step 265, a determination is made as to whether component aging has revealed a design margin problem. That is, a determination is made as to whether component tolerances associated with aging have led to a reduction or elimination of a necessary design margin for the failing unit. If such a design margin problem is found, then the premature service life analysis routine is invoked at step 240. Otherwise, the method 200 proceeds to step 270.

At step 230, the monitor routine is invoked. This monitor routine measures, records and tracks the return and failure rates of the parts.

At step 240, the premature service life analysis routine is invoked. This service life analysis routine comprises the steps of publishing the findings that an EOSL has not been reached.

At step 270, an end of service life (EOSL) routine is invoked. The end of service life routine may comprise, illustratively, a publishing or storage in memory of a finding that an EOSL has been reached, the triggering of a spares order (accessing an inventory system etc.), propagation of failure indicators (to a network controller or manager). The EOSL routine may also comprise the transmission and/or storage of identified environmental, design, manufacturing or other problems (such as noted above with respect to steps 220-265).

FIG. 3 depicts a flow diagram of a method for performing life data analysis according to an embodiment of the subject invention. The method provides a life data analysis (e.g., a Weibull analysis) to predict the life of a product or unit under investigation (UUI) in a population of products/units by fitting a statistical distribution to life data from a representative sample of products/units. The parameterized distribution for the data set is then used to estimate important life characteristics of the product such as reliability, probability of failure at a specific time, mean life, failure rate and so on.

Specifically, the method 300 of FIG. 3 is entered at step 305, when life data for a unit to be investigated is received (e.g., after step 210). As noted in box 310, such life data may comprise shipment information, returned goods information, failure symptom information, environmental condition information and other information.

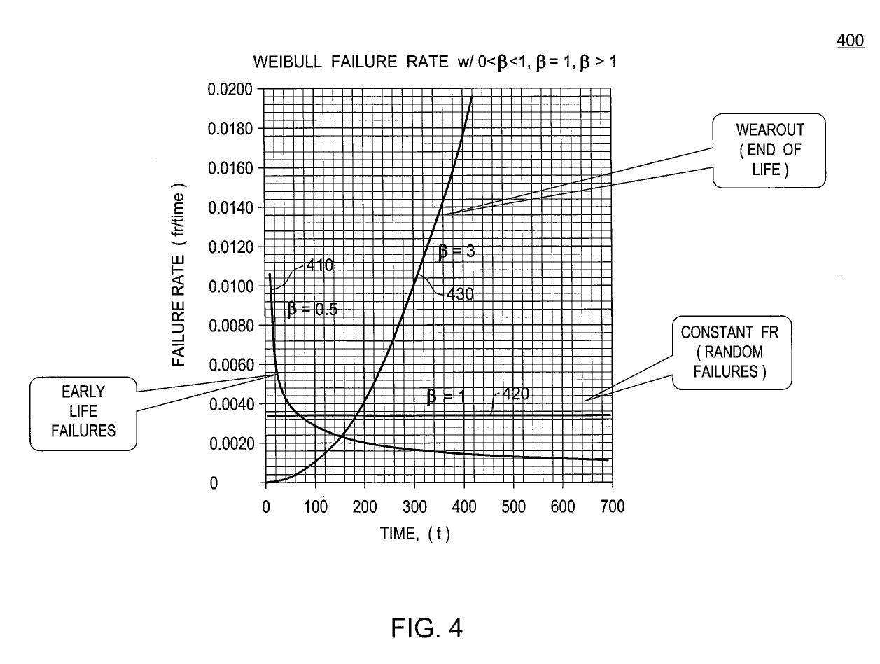

At step 315, a lifetime distribution (e.g., Weibull) is used to fit the received a life data such that the life of the unit being investigated may be modeled. Based on this modeling (as discussed in more detail below with respect to FIG. 4) a determination of the life stage of the UUI may be determined (i.e., early-life, mid-life or end of life).

At step 320, the life data is partitioned into like failure modes.

At step 325, graphical plots and/or results are generated to provide estimates of the life characteristics of the unit under investigation. Referring to box 330, such plots and/or results are used to present reliability predictions, mean life predictions, failure mode predictions and/or other predictions.

By fitting the life data to a Weibull distribution, a measure of the corresponding beta parameter provides an indication of the life stage of the UUI, as noted below with respect to FIG. 4.

FIG. 4 graphically depicts Weibull plots for different failure rates. Specifically, FIG. 4 graphically depicts a plot 400 of failure rate as a function of time for Weibull failure rates for different beta values; namely, a first curve 410 depicting failure rates for beta values between zero and one (illustratively 0.5), a second curve 420 depicting failure rates for a beta value of one, and a third curve 430 depicting failure rates for beta values greater than one (illustratively three). The plot shows that early life failures are associated with a beta of between zero and one, end-of-life or wear out failures are associated with a beta greater than one, and mid-life or constant/random failures are associated with a beta of approximately one.

In an embodiment of the invention modeling life characteristics of units under investigation, beta values are determined such that a determination is made as to whether the unit under investigation is experiencing early life, useful life or end of life failures. In the case of end-of-life failures, appropriate end of service life actions may be taken, such as discussed herein with respect to the various figures.

The above-described embodiments of the invention may be implemented within the context of methods, computer readable media and computer program processes. As such, it is contemplated that some of the steps discussed herein as software processes may be implemented within hardware, for example as circuitry that cooperates with the processor to perform various steps.

The invention may also be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

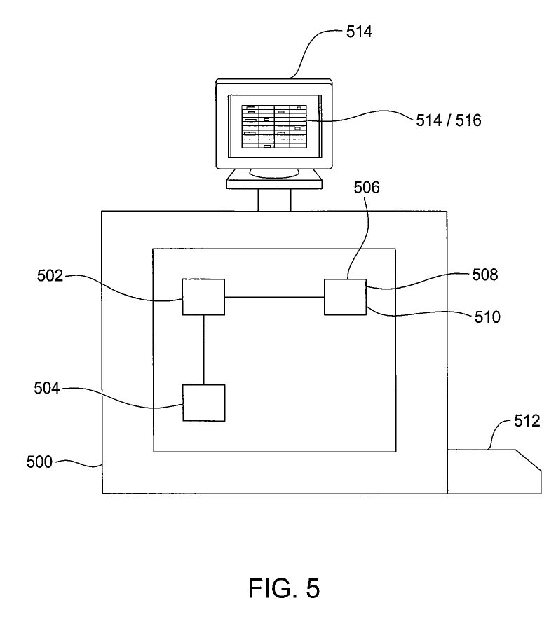

An apparatus in accordance with one embodiment of the subject invention is presented in FIG. 5. Specifically, FIG. 5 depicts a computer 500 (personal computer, networked workstation, network server or the like). The computer 500 includes at least one central processing unit (CPU) 502, support circuits 504, and memory 506. The CPU 502 may comprise one or more conventionally available microprocessors. The support circuits 504 are well known circuits that comprise power supplies, clocks, input/output interface circuitry and the like. Memory 506 comprises various types of computer readable medium including, but not limited to random access memory, read only memory, removable disk memory, flash memory and various combinations of these types of memory. The memory 506 is sometimes referred to as main memory and may in part be used as cache memory or buffer memory. The memory 506 stores various software packages 508-510 that perform operations essential to the computer 500 and/or interconnected workstations, servers and the like if operating in a network environment. When running a particular software package or program 508-510, the computer 500 becomes a special purpose machine for calculating end of service life (EOSL) and performing other functions as described herein. More specifically, the computer 500 becomes a special purpose machine for calculating EOSL in accordance with methods such as described above.

The computer may contain one or more interfaces 512 selected from the group consisting of a keyboard, mouse, touch screen, keypad, voice-activated interface for entering data (i.e., the aforementioned parameters and variables) into an input template 516 displayed on a display device 514. Upon completion of the EOSL calculations in accordance with methods, an output template 518 showing the results of the calculations is displayed on display device 514.

Although various embodiments that incorporate the teachings of the present invention have been shown and described in detail herein, those skilled in the art can readily devise many other varied embodiments that still incorporate these teachings.

1. A method of calculating an end of service life (EOSL) condition, comprising:
receiving data associated with a unit under investigation (UUI);
determining that the UUI has reached an EOSL condition in response to data indicative of an increasing rate of non-random failures; and
invoking an EOSL process in response to the existence of an EOSL condition.

2. The method of claim 1, wherein said determination of an EOSL condition is only made if said UUI is not associated with a known quality defect.

3. The method of claim 1, wherein said determination of an EOSL condition is only made if said UUI is not associated with a design margin problem.

4. The method of claim 1, wherein said determination of an EOSL condition is only made if said UUI has been operating under acceptable environmental conditions.

5. The method of claim 2, wherein said determination of an EOSL condition is only made if said UUI is not associated with a design margin problem and said UUI has been operating under acceptable environmental conditions.

6. The method of claim 1, wherein said determination of an EOSL condition is only made if said UUI is not associated with customer specific failures.

7. The method of claim 1, wherein in the case of said UUI comprising a mechanical component said determination of an EOSL condition is only made if said UUI has not reached a 10 year service life.

8. The method of claim 1, wherein said non-random failures are measured using one or more of shipment information, returned goods information, failure symptom information and environmental condition information.

9. The method of claim 1, wherein:
said data comprises life data associated with said UUI; and
said step of determining further comprises the step of fitting received life data to a lifetime distribution curve to determine thereby a life stage of the UUI.

10. The method of claim 9, wherein the lifetime distribution curve comprises a Weibull distribution.

11. The method of claim 10, wherein an end of life condition is indicated where the life data fits a Weibull distribution having a beta greater than one.

12. The method of claim 1, wherein said EOSL routine comprises storing in memory an indication that EOSL has been reached for the UUI.

13. The method of claim 1, wherein said EOSL routine comprises triggering an order for a spares order associated with said UUI.

14. The method of claim 1, wherein said EOSL routine comprises transmitting any identified environmental, design or manufacturing conditions associated with the UUI.

15. A computer readable medium containing a program which, when executed by a processor, performs a method of calculating an end of service life (EOSL) condition, comprising:
receiving data associated with a unit under investigation (UUI);
determining that the UUI has reached an EOSL condition in response to data indicative of an increasing rate of non-random failures; and
invoking an EOSL process in response to the existence of an EOSL condition.

16. Apparatus for calculating an end of service life (EOSL) condition, comprising:
means for receiving data associated with a unit under investigation (UUI);
means for determining that the UUI has reached an EOSL condition in response to data indicative of an increasing rate of non-random failures; and
means for invoking an EOSL process in response to the existence of an EOSL condition.
